(19) United States
(12) Patent Application Publication
(10) Pub. No.: US 2025/0296231 A1
(43) Pub. Date: Sep. 25, 2025

(54) ROBOT SYSTEM, CONTROL METHOD, AND RECORDING MEDIUM

(71) Applicant: NEC Corporation, Minato-ku Tokyo (JP)

(72) Inventors: Masumi ICHIEN, Tokyo (JP); Tsutomu MARUYAMA, Tokyo (JP); Youko MORI, Tokyo (JP); Hiromi Muto, Tokyo (JP); Hidekazu Nagaoka, Tokyo (JP)

(73) Assignee: NEC Corporation, Minato-ku Tokyo (JP)

(21) Appl. No.: 18/860,745

(22) PCT Filed: May 31, 2022
(86) PCT No.: PCT/JP2022/022231

§ 371 Date: Oct. 28, 2024

(51) Int. Cl. B25J 9/16

(52) U.S. Cl. CPC B25J 9/1669

(57) ABSTRACT

A robot system includes a robot hand configured to grasp a target object and a processor configured to control, in a case where a control process of moving the target object to a predetermined position is performed, the robot hand so that the target object is moved to a confirmation position where the target object is recognized and the target object is moved from the confirmation position to the predetermined position.

### TECHNICAL FIELD

The present disclosure relates to a robot system, a control method, and a recording medium.

### BACKGROUND ART

Robots are used in various fields such as logistics. Some robots operate autonomously. Patent Document 1 discloses technology related to a computer system for recognizing a position and posture of a physical object based on surface position information of the physical object as the related art.

### PRIOR ART DOCUMENTS

### Patent Document

Patent Document 1: Japanese Unexamined Patent Application, First Publication No. 2017-136677

### SUMMARY

### Technical Problem

In the technology described in Patent Document 1, in a case where surface position information of a target object (described as a physical object in Patent Document 1) deviates from an actual position of a physical object, the target object are recognized in a state that a position and posture of the target object are incorrect. Therefore, in a robot system using the technology described in Patent Document 1, it is difficult to execute a process in which the accuracy of recognition of the target object including a position, posture, and shape of a target object (e.g., a process of packaging a physical object in a cardboard box, a process of reading a barcode assigned to a physical object, or the like) is required.

An objective of an example aspect of the present disclosure is to provide a robot system, a control method, and a recording medium capable of solving the above-described problems.

### Solution to Problem

To achieve the above-described objective, according to an example aspect of the present disclosure, there is provided a robot system including: a grasping mechanism configured to grasp a target object; and a control means configured to control, in a case where a control process of moving the target object to a predetermined position is performed, the grasping mechanism so that the target object is moved to a confirmation position where the target object is recognized and the target object is moved from the confirmation position to the predetermined position.

To achieve the above-described objective, according to another example aspect of the present disclosure, there is provided a control method executed by a robot system, the robot system including a grasping mechanism configured to grasp a target object, the control method including: controlling, in a case where a control process of moving the target object to a predetermined position is performed, the grasping mechanism so that the target object is moved to a confirmation position where the target object is recognized and the target object is moved from the confirmation position to the predetermined position.

To achieve the above-described objective, according to another example aspect of the present disclosure, there is provided a recording medium storing a program for causing a computer of a robot system, which includes a grasping mechanism configured to grasp a target object, to: control, in a case where a control process of moving the target object to a predetermined position is performed, the grasping mechanism so that the target object is moved to a confirmation position where the target object is recognized and the target object is moved from the confirmation position to the predetermined position.

### Advantageous Effects of Invention

According to the example aspects of the present disclosure, it is possible to improve a probability of success in a process in which the accuracy of recognition of a target object is required.

### BRIEF DESCRIPTION OF DRAWINGS

FIG. 1 is a diagram showing an example of a configuration of a robot system according to an example embodiment of the present disclosure.

FIG. 2 is a diagram showing an example of a configuration of a control device according to the example embodiment of the present disclosure.

FIG. 3 is a diagram showing an example of an initial plan sequence generated by a generation unit according to the example embodiment of the present disclosure.

FIG. 4 is a diagram showing an example of an initial plan control signal generated by a control unit according to the example embodiment of the present disclosure.

FIG. 5 is a diagram showing an example of a processing flow of a robot system according to the example embodiment of the present disclosure.

FIG. 6 is a diagram for describing a sequence in the example embodiment of the present disclosure.

FIG. 7 is a diagram showing an example of a configuration of a robot system according to another example embodiment of the present disclosure.

FIG. 8 is a diagram showing an example of a configuration of a robot according to another example embodiment of the present disclosure.

FIG. 9 is a diagram showing an example of a robot system having a minimum configuration according to an example embodiment of the present disclosure.

FIG. 10 is a diagram showing an example of a processing flow of the robot system having the minimum configuration according to the example embodiment of the present disclosure.

FIG. 11 is a schematic block diagram showing a configuration of a computer according to at least one example embodiment.

### EXAMPLE EMBODIMENT

Hereinafter, example embodiments will be described in detail with reference to the drawings.

### Example Embodiment

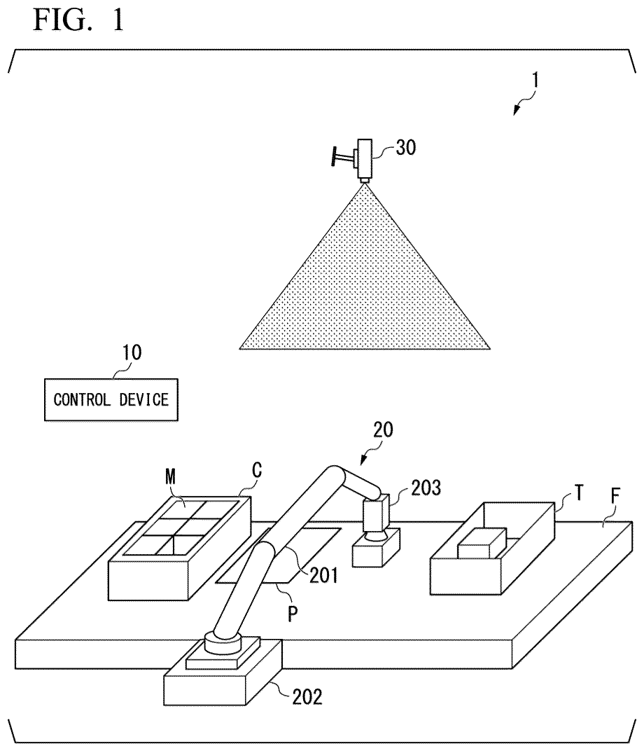

A robot system 1 according to an example embodiment of the present disclosure is a system for moving a target object M placed at a certain position to a destination (an example of a predetermined position) and a system for confirming a state of the target object M at a confirmation position P located between the certain position and the destination. Examples of the destination include a cardboard box C to be described below for packaging the target object M at the time of shipment, a tray T for sorting the target object M at the time of arrival, a position for reading a barcode assigned to the target object M at the time of shipment/arrival, and the like. At the destination, for example, a predetermined process in which the accuracy of recognition of the target object M is required may be performed. The confirmation position P is a position where the target object M is recognized (e.g., a position, posture, shape, or the like of the target object M is recognized anew, i.e., a state of the target object M is corrected as necessary) to facilitate the execution of the above-described predetermined process. Therefore, it is desirable that the state of the target object M be corrected at a position close to the destination where the predetermined process in which the accuracy of recognition of the target object M is required is executed. Therefore, it is desirable that the confirmation position P is a position located between a position where a robot hand 203 (an example of a grasping mechanism) to be described below grasps the target object M (a movement source to be described below) and the destination and is a position closer to the destination than the position where the robot hand 203 grasps the target object M. The confirmation position P may be, for example, a position where the target object M shown by inside of an area located between a certain position and a destination can be placed, as shown in FIG. 1 to be described below. Moreover, the confirmation position P may be a position in a state in which a robot 20 to be described below grasps the target object M.

In addition, the confirmation position P may be, for example, a confirmation position in control according to a control signal based on a movement path of the target object M determined by simulation to be described below. Moreover, the confirmation position P may be, for example, a confirmation position where the actual presence of the target object M is confirmed from an image of the target object M captured by the image device 30 to be described below. The robot system 1 is, for example, a system introduced to a warehouse of a logistics center or the like.

### (Configuration of Robot System)

FIG. 1 is a diagram showing an example of a configuration of the robot system 1 according to an example embodiment of the present disclosure. As shown in FIG. 1, the robot system 1 includes a control device 10, a robot 20 (an example of a robot), and an image device 30. In FIG. 1, a floor F, the target object M, the tray T, the cardboard box C, and the confirmation position P are shown. Hereinafter, the robot system 1 in an example in which the robot system 1 moves the target object M from the tray T to the cardboard box C via the confirmation position P will be described.

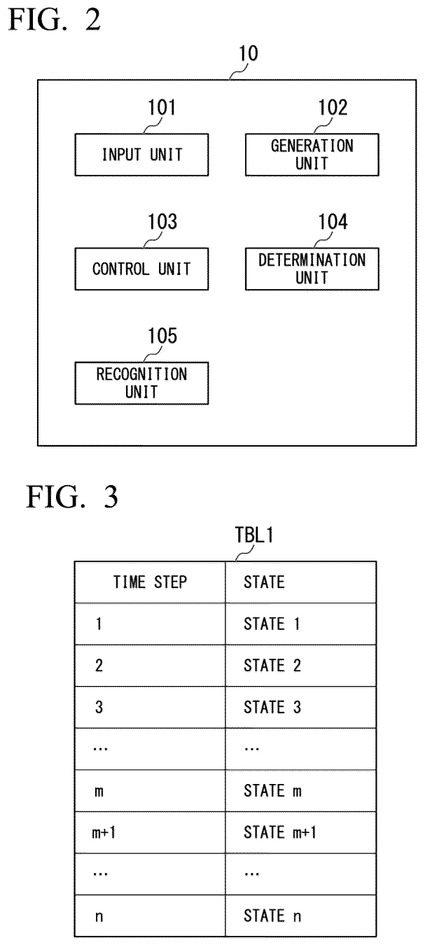

FIG. 2 is a diagram showing an example of a configuration of the control device 10 according to the example embodiment of the present disclosure. As shown in FIG. 2, the control device 10 includes an input unit 101, a generation unit 102 (an example of a first generation means and an example of a second generation means), a control unit 103 (an example of a control means), a determination unit 104 (an example of a determination means), and a recognition unit 105 (an example of recognition means).

The input unit 101 inputs a task goal and constraint conditions to the generation unit 102. Examples of the task goal include information indicating a type of target object M, the number of target objects M to be moved, a movement source of the target object M, and a destination of the target object M and the like. Examples of the constraint conditions include an entry prohibition area in a case where the target object M is moved, an area deviating from a movable range of the robot 20, a condition of a face of the target object M related to a grasp of the target object M, release of the grasp of the target object M, or a switching of the target object M from one robot arm to another robot arm, and the like. As a task goal, the input unit 101 may receive, for example, an input “Move three products A from the tray T to the cardboard box C,” from a user, identify that the type of target object M to be moved is parts A, the number of target objects M to be moved is three, the movement source of the target object M is the tray T, and the destination of the target object M is the cardboard box C, and input identified information to the generation unit 102. Moreover, the position of the target object M identified in the image captured by the image device 30 may be designated as the movement source of the target object M. Moreover, the input unit 101, for example, may receive a position of an obstacle during movement of the target object M from the movement source to the destination from the user as a constraint condition indicating the entry prohibition area and input information thereof to the generation unit 102. Moreover, a file indicating a constraint condition is stored in a storage device and the input unit 101 may input the constraint condition indicated in the file to the generation unit 102 and/or the generation unit 102 may read the constraint condition directly from the file. That is, as long as the generation unit 102 can obtain the necessary task goal and the necessary constraint conditions, the acquisition method may be of any type.

The generation unit 102 generates an initial plan (an example of a first plan) indicating a flow of an operation of the robot 20 based on the task goal and the constraint conditions input by the input unit 101. For example, in a case where the task goal and the constraint conditions are input by the input unit 101, the generation unit 102 acquires an image of the movement source of the target object M indicated in the task goal from the image device 30. The generation unit 102 can recognize a state of the target object M (i.e., a position and posture thereof) at the movement source from the image acquired from the image device 30. The generation unit 102 generates a movement path (a part of the initial plan) including the states of the target object M from the state of the target object M at the movement source to the state of the target object M at the destination via the confirmation position P, for example, according to simulation. Information indicating the movement path is information necessary for the control unit 103 to generate a control signal that controls the robot 20. Also, the generation unit 102 generates information (i.e., a sequence (a part of the initial plan)) indicating a state of the robot 20 for each of time steps during the process (a type of target object M (including a shape thereof), a position and posture of the robot 20, an operation of the robot 20 (the strength of a grasp of the target object M or the like), and the like), for example, according to simulation. The generation unit 102 outputs the generated sequence to the control unit 103.

Moreover, as will be described below, in a case where the determination unit 104 determines that it is necessary to generate a new plan (an example of a second plan) for the target object M at the confirmation position P, the generation unit 102 generates a new plan based on a recognition result of the target object M recognized by the recognition unit 105 at the confirmation position P. For example, as will be described below, the recognition unit 105 acquires an image of the target object M at the confirmation position P from the image device 30. The recognition unit 105 recognizes the state of the target object M (i.e., a position and posture thereof) at the confirmation position P from the image acquired from the image device 30. The generation unit 102 generates a movement path (a part of a new plan) necessary for the control unit 103 to generate a control signal for controlling the robot 20, for example, according to simulation. The movement path includes the states of the target object M from the state of the target object M at the confirmation position P recognized by the recognition unit 105 to the state of the target object M at the destination. Also, the generation unit 102 generates information (i.e., a sequence (a part of the new plan)) indicating a state of the robot 20 for each of time steps during the process (a type of target object M (including a shape thereof), a position and posture of the robot 20 based on a movement path, and the like), for example, according to simulation. The generation unit 102 outputs the generated sequence to the control unit 103. In addition, the generation unit 102 may be implemented using artificial intelligence (AI) technologies including temporal logic, reinforcement learning, optimization technology, and the like.

FIG. 3 is a diagram showing an example of an initial design sequence TBL1 generated by the generation unit 102 according to the example embodiment of the present disclosure. For example, as shown in FIG. 3, the initial design sequence TBL1 generated by the generation unit 102 is, for example, a sequence indicating each state of the robot 20 for each of n time steps from the movement source to the destination of the target object M.

In a case where a control process of moving the target object M to the destination is performed, the control unit 103 performs a control process of moving the target object M to the confirmation position where the target object M is recognized and moving the target object M from the confirmation position to the destination.

For example, the control unit 103 generates a control signal for controlling the robot 20 based on the sequence output by the generation unit 102. In addition, the control unit 103 may generate a control signal for optimizing an evaluation function in a case where the control signal is generated. Examples of the evaluation function include a function indicating an amount of energy to be consumed by the robot 20 in a case where the target object M is moved, a function indicating a distance along a path along which the target object M is moved, and the like. The control unit 103 outputs the generated control signal to the robot 20.

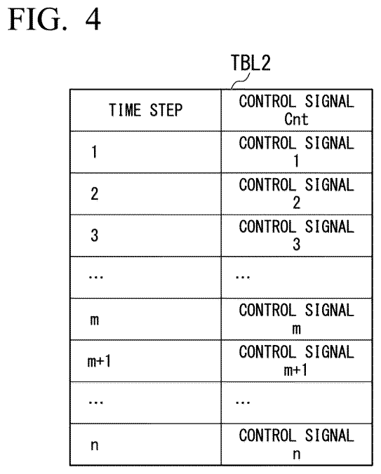

FIG. 4 is a diagram showing an example of an initial plan control signal Cnt generated by the control unit 103 according to the example embodiment of the present disclosure. For example, as shown in FIG. 4, the initial plan control signal Cnt generated by the control unit 103 is, for example, each control signal for each of n time steps from the movement source to the destination of the target object M.

The determination unit 104 determines whether or not it is necessary to generate a new plan for the target object M at the confirmation position P. For example, the determination unit 104 determines that it is necessary to generate a new plan for the target object M at the confirmation position P in a case where the accuracy of recognition of the target object M based on the image of the target object M captured by the image device 30 at the movement source is quantified (and calculated as a score) and the calculated score is less than a predetermined score. Moreover, in a case where the calculated score is greater than or equal to the predetermined score, the determination unit 104 determines that it is not necessary to generate a new plan for the target object M at the confirmation position P. Moreover, for example, the determination unit 104 compares the state of the target object M indicated in the image captured by the image device 30 at the confirmation position P with the state of the target object M at the confirmation position P indicated in the first plan and determines that it is not necessary to generate a new plan for the target object M at the confirmation position P, for example, in a case where a state difference is less than or equal to a predetermined value. Moreover, the determination unit 104 determines that it is necessary to generate a new plan for the target object M at the confirmation position P, for example, in a case where the state difference exceeds the predetermined value. In addition, a difference between a position predicted from the control signal and an actual position of the target object M indicated in the image captured by the image device 30 at the confirmation position P and a difference between a posture of the target object M at the confirmation position P predicted from the control signal and an actual posture of the target object M at the actual confirmation position P from the image captured by the image device 30 at the confirmation position P are quantified and a maximum value that can be tolerated for a sum of the quantified differences may be used as the predetermined value as an example. In other words, it can be said that the determination unit 104 determines whether or not the difference between the state of the target object M indicated in the captured image and the state of the target object M at the confirmation position P indicated in the first plan satisfies a condition for generating the plan. In addition, details of a process in which the control device 10 controls the robot 20 will be described below.

The recognition unit 105 recognizes the target object M at the confirmation position P. For example, the recognition unit 105 acquires an image of the target object M at the confirmation position P from the image device 30. The recognition unit 105 recognizes a state of the target object M (i.e., a position and posture thereof) at the confirmation position P from the image acquired from the image device 30. The recognition unit 105 outputs the state of the target object M recognized at the confirmation position P to the generation unit 102.

The robot 20 grasps the target object M in accordance with the control signal output by the control unit 103 and moves the target object M from the movement source to the destination. As shown in FIG. 1, the robot 20 includes a robot arm 201, a pedestal 202, and a robot hand 203 (an example of a grasping mechanism). The robot arm 201 is connected to the pedestal 202. The robot hand 203 is connected to an end on the opposite side of an end where the robot arm 201 is connected to the pedestal 202. The robot hand 203 includes, for example, two or more pseudo-fingers or vacuums resembling fingers of a human, animal, or the like. The robot hand 203 grasps the target object M in accordance with a control signal output by the control device 10. The robot arm 201 moves the target object M from the movement source to the destination in accordance with the control signal output by the control device 10.

In each example embodiment of the present disclosure, a “grasp” includes “adsorption” in which the target object M is suctioned by a vacuum or the like and a “pinch” in which a physical object is pinched by two or more pseudo-fingers resembling fingers of a human, animal, or the like.

The image device 30 captures a state of the target object M. The image device 30 is, for example, an industrial camera, which can identify the state of the target object M (i.e., a position and posture thereof). The image captured by the image device 30 is output to the generation unit 102.

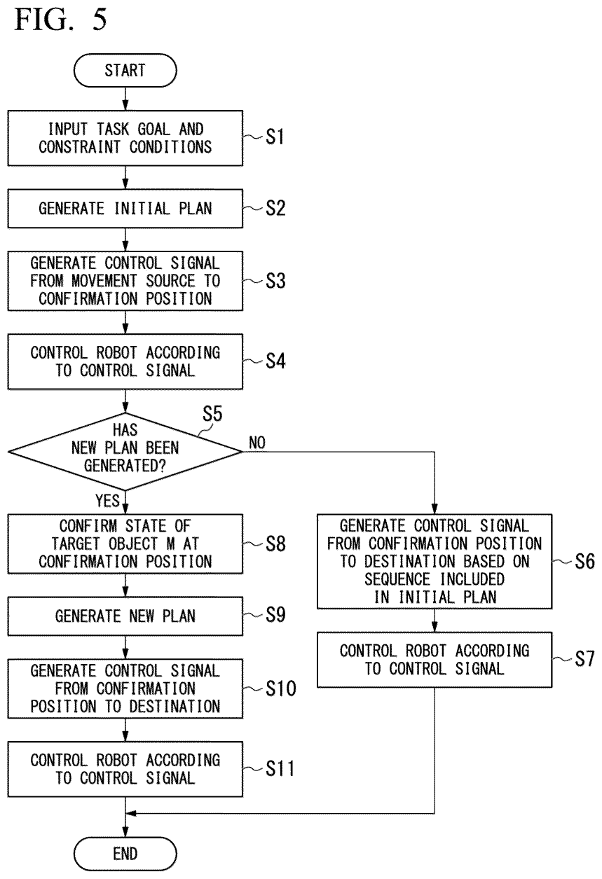

FIG. 5 is a diagram showing an example of a processing flow of the robot system 1 according to the example embodiment of the present disclosure. Next, details of a process in which the control device 10 of the robot system 1 controls the robot 20 will be described with reference to FIG. 5. In addition, it is assumed that a task goal and constraint conditions are input to the input unit 101.

The input unit 101 inputs the task goal and constraint conditions to the generation unit 102 (step S1). The generation unit 102 generates an initial plan (an example of a first plan) indicating a flow of an operation of the robot 20 based on the task goal and constraint conditions input by the input unit 101 (step S2). The generation unit 102 outputs a sequence for performing movement from the movement source (e.g., the tray T) to the confirmation position P among sequences included in the generated initial plan to the control unit 103.

The control unit 103 generates a control signal for performing a control process in which the robot hand 203 of the robot 20 grasps the target object M and moves the target object M from the movement source to the confirmation position P based on a sequence for performing movement from the movement source to the confirmation position P output by the generation unit 102 (step S3). The control unit 103 controls the robot 20 by outputting the generated control signal to the robot 20 (step S4). Thereby, the robot hand 203 of the robot 20 can grasp the target object M and move the target object M from the movement source to the confirmation position P.

In a case where a control process of moving the target object M from the movement source to the confirmation position P performed by the control unit 103 ends, the determination unit 104 determines whether or not it is necessary to generate a new plan for the target object M at the confirmation position P (step S5).

In a case where the determination unit 104 determines that it is not necessary to generate a new plan for the target object M at the confirmation position P (NO in step S5), the generation unit 102 outputs a sequence for performing movement from the confirmation position P to the destination (e.g., the cardboard box C) among the sequences included in the generated initial plan to the control unit 103.

The control unit 103 generates a control signal for performing a control process in which the robot hand 203 of the robot 20 grasps the target object M and moves the target object M from the confirmation position P to the destination based on the sequence for performing movement from the confirmation position P to the destination output by the generation unit 102 (step S6). The control unit 103 controls the robot 20 by outputting the generated control signal to the robot 20 (step S7). Thereby, the robot hand 203 of the robot 20 can grasp the target object M and move the target object M from the confirmation position P to the destination.

In a case where the determination unit 104 determines that it is necessary to generate a new plan for the target object M at the confirmation position P (YES in step S5), the recognition unit 105 acquires an image of the target object M at the confirmation position P from the image device 30. The recognition unit 105 recognizes a state of the target object M (i.e., a position and posture thereof) at the confirmation position P from the image acquired from the image device 30 (step S8). The recognition unit 105 outputs the recognized state of the target object M at the confirmation position P to the generation unit 102.

The generation unit 102 generates a new plan based on the recognition result of the target object M recognized by the recognition unit 105 at the confirmation position P (step S9). For example, the recognition unit 105 acquires an image of the target object M at the confirmation position P from the image device 30. The recognition unit 105 recognizes a state of the target object M (i.e., a position and posture thereof) at the confirmation position P from the image acquired from the image device 30. The generation unit 102 generates a movement path (a part of the new plan) necessary for the control unit 103 to generate a control signal for controlling the robot 20, for example, according to simulation. Also, the generation unit 102 generates information (i.e., a sequence (a part of the new plan)) indicating each state of the robot 20 for each of time steps during the process (a type of target object M (including a shape thereof), a position and posture of the robot 20 based on a movement path, and the like) and the like, for example, according to simulation. The generation unit 102 outputs the sequence included in the generated new plan to the control unit 103.

The control unit 103 generates a control signal for performing a control process in which the robot hand 203 of the robot 20 grasps the target object M and moves the target object M from the confirmation position P to the destination based on the sequence included in the new plan for performing movement from the confirmation position P to the destination output by the generation unit 102 (step S10). The control unit 103 controls the robot 20 by outputting the generated control signal to the robot 20 (step S11). Thereby, the robot hand 203 of the robot 20 can grasp the target object M and move the target object M from the confirmation position P to the destination.

### (Advantages)

As described above, the robot system 1 according to the example embodiment of the present disclosure has been described. In the robot system 1, the robot hand 203 (an example of the grasping mechanism) grasps the target object M. The control unit 103 (an example of the control means) controls the robot hand 203 so that the target object M is moved to a confirmation position where the target object M is recognized and the target object M is moved from the confirmation position to a destination (an example of a predetermined position) in a case where a control process of moving the target object M to the destination is performed.

Thereby, the robot system 1 can improve a probability of success in a process in which the accuracy of recognition of the target object is required.

In another example embodiment of the present disclosure, the control device 10 may be included in the robot 20.

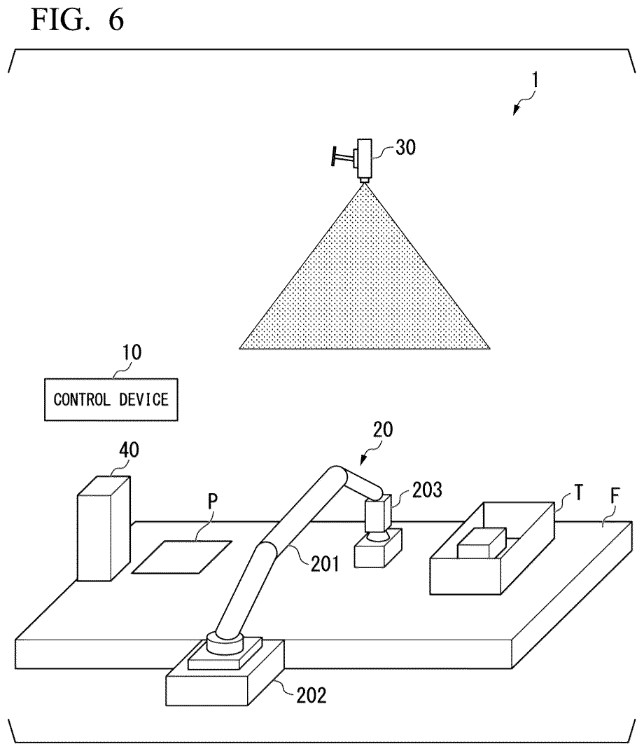

Moreover, a process of moving the target object M from the tray T to the cardboard box C in the processing flow of the robot system 1 according to the example embodiment of the present disclosure shown by FIG. 5 described above has been described. However, the process performed by the robot system 1 at the destination is not limited to the movement of the target object M to the cardboard box C in another example embodiment of the present disclosure. FIG. 6 is a diagram showing an example of a configuration of the robot system 1 according to another example embodiment of the present disclosure. As shown in FIG. 6, the robot system 1 according to another example embodiment of the present disclosure includes a control device 10, a robot 20 (an example of a robot), an image device 30, and a barcode reader 40. The target object M according to another example embodiment of the present disclosure is assigned a barcode. This barcode includes information indicating a type of product that is the target object M. The barcode reader 40 is a device for reading the barcode assigned to the target object M. Also, the control device 10 according to another example embodiment of the present disclosure may change a destination of the robot system 1 according to the example embodiment of the present disclosure from a cardboard box C to a position where the barcode reader 40 can read the barcode assigned to the target object M and then may perform a control process of moving the target object M from the movement source to the destination as in the control device 10 according to the example embodiment of the present disclosure.

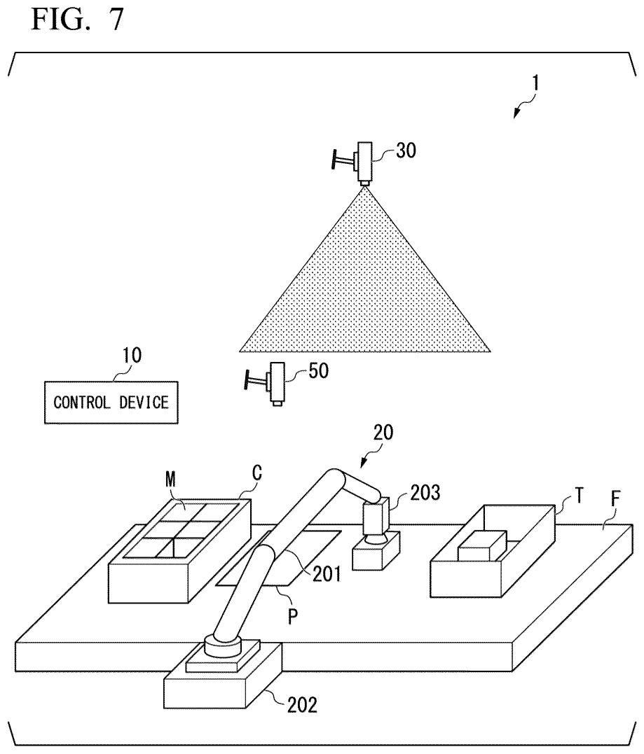

Moreover, the recognition unit 105 for recognizing the target object M based on an image of the target object M captured by the image device 30 at the confirmation position in the robot system 1 according to the example embodiment of the present disclosure has been described. However, another example embodiment of the present disclosure is not limited to the case where the recognition unit 105 recognizes the target object M based on the image captured by the image device 30. FIG. 7 is a diagram showing an example of a configuration of a robot system 1 according to another example embodiment of the present disclosure. As shown in FIG. 7, the robot system 1 according to another example embodiment of the present disclosure includes a control device 10, a robot 20 (an example of a robot), an image device 30, and an image device 50. The image device 50 captures a state of the target object M at the confirmation position P. The image device 50 is, for example, an industrial camera, which can identify the state of the target object M (i.e., a position and posture thereof). The image captured by the image device 50 is output to the generation unit 102 in the control device 10. Also, the control device 10 according to another example embodiment of the present disclosure may perform a process similar to that of the control device 10 according to the example embodiment of the present disclosure using an image captured by the image device 30 instead of an image of the target object M at the confirmation position P captured by the image device 50 in the example embodiment of the present disclosure.

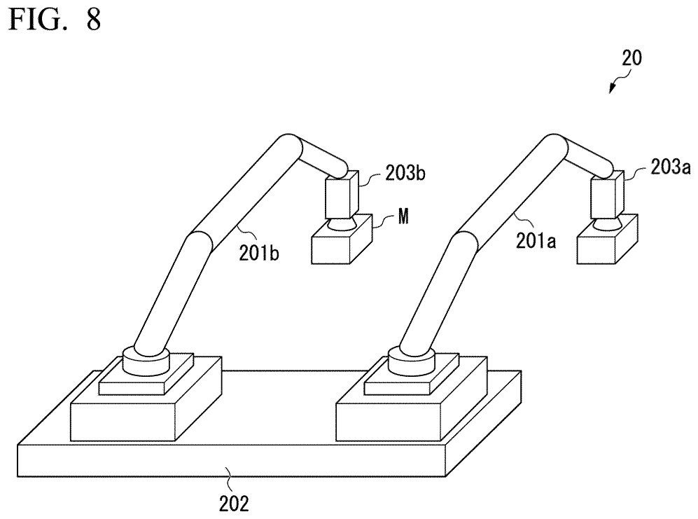

Moreover, it has been described that the robot 20 of the robot system 1 according to the example embodiment of the present disclosure includes a robot arm 201, a pedestal 202, and a robot hand 203 (an example of a grasping mechanism), that is, the robot 20 is a single arm robot. However, the robot 20 of the robot system 1 according to another example embodiment of the present disclosure is not limited to the single-arm robot. FIG. 8 is a diagram showing an example of a configuration of the robot 20 according to another example embodiment of the present disclosure. As shown in FIG. 8, the robot 20 according to another example embodiment of the present disclosure (an example of a robot) may include robot arms 201a, 201b, and the like, a pedestal 202, and robot hands 203a, 203b, and the like (examples of a grasping mechanism), that is, the robot 20 is a robot having two arms or three or more arms. The control unit 103 (an example of a control means) of the control device 10 according to another example embodiment of the present disclosure generates a control signal for each of the plurality of arms (i.e., each of the robot arms 201a, 201b, and the like and the robot hands 203a, 203b, and the like) based on a sequence for moving the target object M from the movement source to the destination (an example of a predetermined position). According to this control signal, each of the robot hands 203a, 203b, and the like works together to move the target object M from the movement source to the destination.

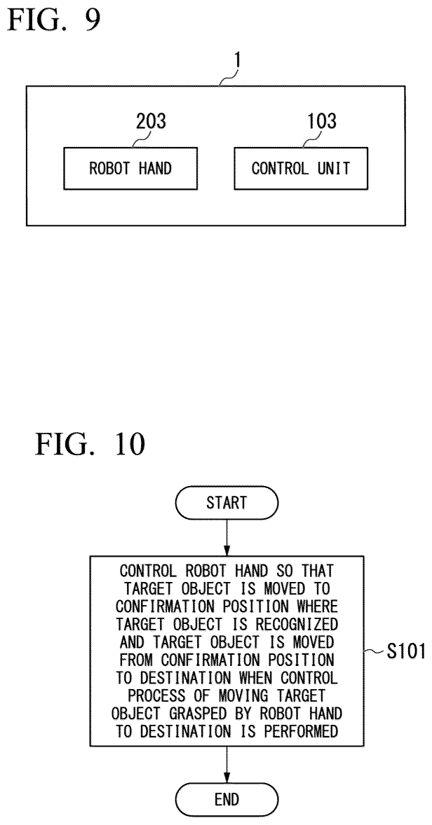

Next, the robot system 1 having the minimum configuration according to the example embodiment of the present disclosure will be described. FIG. 9 is a diagram showing an example of the robot system 1 having the minimum configuration according to the example embodiment of the present disclosure. As shown in FIG. 9, the robot system 1 having the minimum configuration includes a robot hand 203 (an example of a grasping mechanism) and a control unit 103 (an example of a control means). The robot hand 203 grasps the target object M. The robot hand 203 can be implemented, for example, using the functions of the robot hand 203 exemplified in FIG. 1. In a case where a control process of moving the target object M to a destination (an example of a predetermined position) is performed, the control unit 103 controls the robot hand 203 so that the target object M is moved to a confirmation position where the target object M is recognized and the target object M is moved from the confirmation position to the destination. The control unit 103 can be implemented, for example, using the functions of the control unit 103 exemplified in FIG. 2.

Next, a process of the robot system 1 having the minimum configuration will be described. FIG. 10 is a diagram showing an example of a processing flow of the robot system 1 having a minimum configuration according to an example embodiment of the present disclosure. Here, the process of the robot system 1 having the minimum configuration will be described with reference to FIG. 10.

In a case where the control unit 103 controls the robot hand 203 so that the target object M is moved to a confirmation position where the target object M is recognized and the target object M is moved from the confirmation position to a destination in a case where a control process in which the target object M grasped by the robot hand 203 is moved to the destination is performed (step S101).

As described above, the robot system 1 having the minimum configuration according to the example embodiment of the present disclosure has been described. The robot system 1 can improve a probability of success in a process in which the accuracy of recognition of the target object is required.

In addition, in a process according to each example embodiment of the present disclosure, the order of processing may be swapped in a range in which an appropriate process is performed.

Moreover, the process in each example embodiment of the present disclosure may be a combination of processes in the example embodiments in a range in which an appropriate process is performed. For example, the robot system 1 shown in FIG. 6 may further include the image device 50 shown in FIG. 7. Also, the recognition unit 105 of the robot system 1 for reading the barcode assigned by the barcode reader 40 to the target object M may perform a process using the image captured by the image device 30 instead of the image of the target object M captured by the image device 30 at the confirmation position P. Moreover, for example, the robot system 1 shown in each of FIGS. 6 and 7 may include a robot 20 shown in FIGS. 8 instead of the robot 20 shown in each of FIGS. 6 and 7. The control unit 103 (an example of a control means) of the control device 10 may generate a control signal for each of a plurality of arms (i.e., each of the robot arms 201a, 201b, and the like and the robot hands 203a, 203b, and the like) based on a sequence for moving the target object M from the movement source to the destination (an example of a predetermined position).

Although example embodiments of the present disclosure have been described, the above-described robot system 1, the control device 10, the input unit 101, the generation unit 102, the control unit 103, the determination unit 104, the recognition unit 105, the robot 20, the image device 30, and other control devices may have a computer device therein. The process of the above-described processing is stored on a computer-readable recording medium in the form of a program, and the above process is performed by the computer reading and executing the program. A specific example of the computer is shown below.

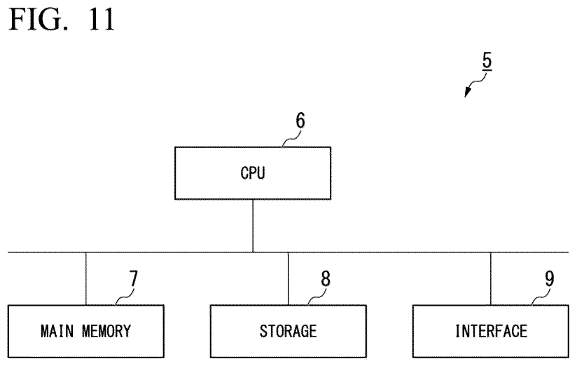

FIG. 11 is a schematic block diagram showing a configuration of a computer according to at least one example embodiment. As shown in FIG. 11, a computer 5 includes a central processing unit (CPU) 6, a main memory 7, a storage 8, and an interface 9. For example, each of the above-described robot system 1, the control device 10, the input unit 101, the generation unit 102, the control unit 103, the determination unit 104, the recognition unit 105, the robot 20, the image device 30, and other control devices is installed in the computer 5. Also, the operation of each processing unit described above is stored in the storage 8 in the form of a program. The CPU 6 reads the program from the storage 8, loads the program into the main memory 7, and executes the above-described process in accordance with the program. Moreover, the CPU 6 secures a storage area corresponding to each of the above-described storage units in the main memory 7 in accordance with the program.

Examples of the storage 8 include a hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like. The storage 8 may be an internal medium directly connected to a bus of the computer 5 or an external medium connected to the computer 5 via the interface 9 or a communication line. Also, in a case where the above program is distributed to the computer 5 via a communication line, the computer 5 receiving the distributed program may load the program into the main memory 7 and execute the above process. In at least one example embodiment, the storage 8 is a non-transitory tangible storage medium.

Moreover, the program may be a program for implementing some of the above-mentioned functions. Furthermore, the program may be a file for implementing the above-described function in combination with another program already stored in the computer system, a so-called differential file (differential program).

Although several example embodiments of the present disclosure have been described, these example embodiments are examples and do not limit the scope of the present disclosure. In relation to these example embodiments, various additions, omissions, substitutions, and other modifications can be made without departing from the spirit or scope of the present disclosure.

Although some or all of the above-described example embodiments may also be described as in the following supplementary notes, the present disclosure is not limited to the following supplementary notes.

### (Supplementary Note 1)

A robot system including:

a grasping mechanism configured to grasp a target object; and

a control means configured to control, in a case where a control process of moving the target object to a predetermined position is performed, the grasping mechanism so that the target object is moved to a confirmation position where the target object is recognized and the target object is moved from the confirmation position to the predetermined position.

### (Supplementary Note 2)

The robot system according to supplementary note 1, including a robot,

wherein the grasping mechanism is included in the robot.

### (Supplementary Note 3)

The robot system according to supplementary note 1 or 3, wherein the confirmation position is located between a position where the grasping mechanism has grasped the target object and the predetermined position, and is closer to the predetermined position than the position where the grasping mechanism has grasped the target object.

### (Supplementary Note 4)

The robot system according to any one of supplementary notes 1 to 3, including a recognition means configured to recognize the target object at the confirmation position,

wherein the control means performs a control process of moving the target object from the confirmation position to the predetermined position after the recognition means recognizes the target object.

### (Supplementary Note 5)

The robot system according to any one of supplementary notes 1 to 4, including a first generation means configured to generate a first plan including a control process of moving the target object to the predetermined position,

wherein the control means causes the target object to move to the confirmation position based on the first plan.

### (Supplementary Note 6)

The robot system according to any one of supplementary notes 1 to 5, including a determination means configured to determine whether or not to generate a second plan, which includes a control process of moving the target object from the confirmation position to the predetermined position, at the confirmation position.

### (Supplementary Note 7)

The robot system according to supplementary note 6, including a second generation means configured to generate the second plan in a case where the determination means determines to generate the second plan,

wherein the control means causes the target object to move from the confirmation position to the predetermined position based on the second plan.

### (Supplementary Note 8)

A control method executed by a robot system, the robot system including a grasping mechanism configured to grasp a target object, the control method including:

controlling, in a case where a control process of moving the target object to a predetermined position is performed, the grasping mechanism so that the target object is moved to a confirmation position where the target object is recognized and the target object is moved from the confirmation position to the predetermined position in a case where a control process of moving the target object to the predetermined position is performed.

### (Supplementary Note 9)

A recording medium storing a program for causing a computer of a robot system, which includes a grasping mechanism configured to grasp a target object, to:

control, in a case where a control process of moving the target object to a predetermined position is performed, the grasping mechanism so that the target object is moved to a confirmation position where the target object is recognized and the target object is moved from the confirmation position to the predetermined position.

### INDUSTRIAL APPLICABILITY

According to each of the example aspects of the present disclosure, a probability of success in a process in which the accuracy of recognition of a target object is required can be improved.

### REFERENCE SIGNS LIST

1 Robot system

5 Computer

6 CPU

7 Main memory

8 Storage

9 Interface

10 Control device

20 Robot

30, 50 Image device

101 Input unit

102 Generation unit

103 Control unit

104 Determination unit

105 Recognition unit

201 Robot arm

202 Pedestal

203 Robot hand

C Cardboard box

F Floor

M Target object

P Confirmation position

T Tray

What is claimed is:

1. A robot system comprising:
a robot hand configured to grasp a target object;
a memory configured to store instructions; and
a processor configured to execute the instructions to:
control, in a case where a control process of moving the target object to a predetermined position is performed, the robot hand so that the target object is moved to a confirmation position where the target object is recognized and the target object is moved from the confirmation position to the predetermined position.

The robot system according to claim 1, comprising a robot,
wherein the robot hand is included in the robot.

3. The robot system according to claim 1, wherein the confirmation position is located between a position where the robot hand has grasped the target object and the predetermined position, and is closer to the predetermined position than the position where the robot hand has grasped the target object.

4. The robot system according to claim 1, wherein the processor is configured to recognize the target object at the confirmation position; and
perform a control process of moving the target object from the confirmation position to the predetermined position after the processor recognizes the target object.

5. The robot system according to claim 1, wherein the processor is configured to:
generate a first plan including a control process of moving the target object to the predetermined position; and
cause the target object to move to the confirmation position based on the first plan.

6. The robot system according to claim 1, wherein the processor is configured to determine whether or not to generate a second plan, which includes a control process of moving the target object from the confirmation position to the predetermined position, at the confirmation position.

7. The robot system according to claim 6, wherein the processor is configured to:
generate the second plan in a case where the processor determines to generate the second plan; and
cause the target object to move from the confirmation position to the predetermined position based on the second plan.

8. A control method executed by a robot system, the robot system including a robot hand configured to grasp a target object, the control method comprising:
controlling, in a case where a control process of moving the target object to a predetermined position is performed, the robot hand so that the target object is moved to a confirmation position where the target object is recognized and the target object is moved from the confirmation position to the predetermined position.

9. A non-transitory recording medium storing a program for causing a computer of a robot system, which includes a robot hand configured to grasp a target object, to:
control, in a case where a control process of moving the target object to a predetermined position is performed, the robot hand so that the target object is moved to a confirmation position where the target object is recognized and the target object is moved from the confirmation position to the predetermined position.
